(19) United States
(12) Patent Application Publication
(10) Pub. No.: US 2006/0274700 A1
(43) Pub. Date: Dec. 7, 2006

(54) Autonomous mode for a plurality of nested mobile networks

(76) Inventors: Christophe Janneteau, Bois D'Arcy (FR); Alexis Olivereau, Orsay (FR); Alexandru Petrescu, Orsay (FR)

Correspondence Address: MOTOROLA, INC., 1303 EAST ALGONQUIN ROAD, IL01/3RD, SCHAUMBURG, IL, 60196, US

(21) Appl. No.: 11/143,124

(22) Filed: Jun. 2, 2005

(51) Int. Cl. H04Q 7/24

(52) U.S. Cl. 370/338

(57) ABSTRACT

A method for enabling autonomous mode routing between mobile devices in a plurality of nested mobile networks, the method including the steps of: discovering (305) at least one neighboring mobile device; exchanging (310) routing information with the at least one neighboring mobile device using a plurality of unicast messages; populating (315) an autonomous mode routing table (AMRT) using the routing information, wherein the AMRT includes an entry corresponding to each mobile network in the plurality of nested mobile networks; and forming (320) a connection with the at least one neighboring mobile device for enabling autonomous mode routing with the at least one neighboring mobile device.

### FIELD OF THE INVENTION

The present invention relates generally to a distributed approach for the support of an autonomous mode for a plurality of nested mobile networks.

### BACKGROUND OF THE INVENTION

A host that is connected to a main network infrastructure (such as the Internet) could be configured for either fixed (Internet Protocol) IP or mobile IP. In the case of fixed IP, an IP address assigned to the host does not change, which restricts the mobility of the device. However, in the case of mobile IP, the host could be assigned different IP addresses as it moves, thereby providing mobility to the device. Similarly, when a set of nodes that form a network, move from one place to another, it could be said to be a mobile network. The mobile network, comprising one or more IP subnets, is attached to a main network infrastructure through a router called a mobile router (MR). Examples of such mobile networks comprise a group of nodes moving in a car or a group of nodes in an airplane. A node is defined herein as a device or entity connected to a network such as a computer or some other device like a router, a printer, a laptop, etc. A router is defined herein as a device that forwards data packets along networks. A host is a node that is not a router.

As the car or airplane, for instance, moves from one location to another, the nodes that are connected to a main infrastructure also move along with the car or plane. Session continuity maintenance within the mobile network needs to be maintained as the car or plane moves. The NEMO (Network Mobility) basic protocol provides this continuity. This is made possible by establishing a bi-directional tunnel between the MR and its home agent (HA). When the mobile network, and the MR through which it is connected, moves from one location to another and attaches to a visitor link, it obtains a Care-of-Address (CoA) and the MR registers this CoA with the HA. The MR forwards outgoing packets to a MR's home network through a tunnel formed between the MR and the home network. Similarly, any packets addressed to a node in the mobile network arrive on the home network and are intercepted by the HA and forwarded through the tunnel to the CoA. Therefore, a packet that is transmitted by a correspondent node (CN) [a node situated on the main network infrastructure and communicating with a mobile network node (MNN) behind the MR] to a MNN, does not take a direct path to the MNN, but a circuitous path from the CN to the home network and then to the MNN, and vice-versa.

This circuitous path becomes more complex when mobile networks are nested. Nesting of mobile networks could occur when a mobile network attaches to another mobile network e.g., a mobile network 2 (NEMO2) (connected through a mobile router—MR2) attaches to a mobile network 1 (NEMO1) (connected through a mobile router—MR1). In such a case, a packet from a mobile network node MNN2 in NEMO2 travels to a CN in a much more complex and circuitous path. The path traced is from MNN2 to MR2, then to MR1, then to the home link of MR1, then to the home link of MR2, and then to the CN on the main network infrastructure. As the level of nesting increases, the complexity in the path increases substantially.

When MNN2 and CN are a part of a plurality of nested mobile networks, the transmission path of packets still remains circuitous, even though MNN2 and CN are part of the same plurality of nested mobile networks. Such a scenario would arise even in the same plane, when for example two mobile networks are in the same plane. However, the data packets have to travel around a circuitous path. This introduces a sub-optimal path between such (neighboring) mobile nodes under the same plurality of nested mobile networks. Further, since the packets have to travel through the main network infrastructure, where the home links are situated, the plurality of nested mobile networks have to be connected to the main network infrastructure all the time. This raises another substantial problem when the plurality of nested mobile networks looses its connection with the main network infrastructure, as two mobile devices under the plurality of nested mobile networks cannot communicate with each other. A need therefore arises to implement a method for making it possible for the two mobile devices, forming part of the plurality of nested mobile networks, to communicate with each other, even when such plurality of nested mobile networks has lost its connection with the main network infrastructure i.e. work in an autonomous mode.

There are various methods that deal with communication within a plurality of nested mobile networks, but none of them provide a complete solution. These methods can be broadly classified in three categories. A first category provides optimized transmission in the main network infrastructure, however, it does not support autonomous mode. A second category provides optimized transmission within the plurality of nested mobile networks, however it requires the plurality of nested mobile networks to be connected to the main network infrastructure. A third category supports autonomous mode of transmission, under restricted conditions such as where a root MR is the HA of all the nested MRs.

Apart from the above-mentioned alternatives, an adhoc routing protocol could be useful in providing routing within a plurality of nested mobile networks. However, the adhoc routing protocol is fraught with inflexibilities and complexities. The routing tables implemented for some of the adhoc routing protocols do not contain information about any destination, but only for those destinations with which the mobile device communicates. This can introduce delay in routing packets, during the time to compute the path. Secondly, the procedure for the construction of routing tables in case of some other adhoc routing protocols is cumbersome. Each node using the adhoc protocol needs to build a topology information base (which provides each device with a local representation of the entire network) in order to construct the routing tables. Further, in case of adhoc routing protocol, the process of discovering neighboring nodes, works at Layer 2 (i.e., the data link layer of the well known Open Systems Interconnection (OSI) Model) of the network architecture. However, one cannot assume connectivity at Layer 2 between any two nested mobile routers, there being a possibility of off-the-shelf fixed routers in between. The adhoc routing protocol also requires that explicit signaling be used between any two neighboring nodes to detect when they loose direct connectivity between them. Such inflexibilities in the adhoc routing protocol make it an unsuitable option for implementing an autonomous mode within a plurality of nested mobile networks.

### BRIEF DESCRIPTION OF THE DRAWINGS

A preferred embodiment of the invention is now described, by way of example only, with reference to the accompanying figures in which:

FIG. 1 is a block diagram that indicates generally a plurality of nested mobile networks implementing embodiments of the present invention;

FIG. 2 illustrates a plurality of autonomous mode routing tables stored at the plurality of mobile devices in accordance with embodiments of the present invention;

FIG. 3 is a flow diagram illustrating a method for enabling autonomous mode routing between mobile devices forming a plurality of nested mobile networks in accordance with embodiments of the present invention;

FIG. 4 illustrates a connection between a mobile device and a neighboring mobile device forming part of the plurality of nested mobile networks in accordance with embodiments of the present invention;

FIG. 5 is a flow diagram illustrating a method for a discovery process between a neighboring mobile device communicating with another mobile device in accordance with embodiments of the present invention;

FIG. 6 is a flow diagram illustrating a method for negotiating an autonomous mode protocol between a mobile device and a neighboring mobile device in accordance with embodiments of the present invention;

FIG. 7 is a flow diagram illustrating a method for receiving routing information in accordance with embodiments of the present invention;

FIG. 8 is a flow diagram illustrating a method for generating an Autonomous Mode Routing Table (AMRT) in accordance with embodiments of the present invention;

FIG. 9 is a flow diagram illustrating a method for updating an AMRT in accordance with embodiments of the present invention;

FIG. 10 illustrates an overall sequence of events that occur for generating and updating an AMRT in an aggregation in accordance with embodiments of the present invention.

FIG. 11 is a flow diagram illustrating a method for routing in an aggregation based on an AMRT in accordance with embodiments of the present invention; and

FIG. 12 is a block diagram of a mobile device capable of autonomous mode routing in accordance with embodiments of the present invention.

### DETAILED DESCRIPTION OF THE INVENTION

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, common and well-understood elements that are useful or necessary in a commercially feasible embodiment may not be depicted in order to facilitate a less obstructed view of these various embodiments. Also, elements shown in the figures have not necessarily been drawn to scale. For example, the dimensions of some of the elements are exaggerated relative to each other. Further, where considered appropriate, reference numerals have been repeated among the figures to indicate corresponding elements.

Generally speaking, the present invention discloses a mechanism that provides support for an autonomous mode in a plurality of nested mobile networks. The mechanism also provides an optimal routing path between any two mobile devices forming part of the plurality of nested mobile networks, which provides advantages even in a connected mode (i.e. when a root mobile router, that connects the plurality of nested mobile networks to a core network infrastructure, has connectivity to the core network infrastructure). The present invention generally relates to a distributed approach for implementing the autonomous mode in the plurality of nested mobile networks. The approach typically comprises a plurality of mobile routers forming an overlay routing topology. Those skilled in the art will appreciate that the above recognized advantages and other advantages described herein are merely exemplary and are not meant to be a complete rendering of all of the advantages of the various embodiments of the present invention.

The terms used in the present disclosure are explained herein. The explanation has been provided for the sake of clarity and it should not, in any manner, be construed to restrict the meaning of a particular term, and any other term used with it, to the explanation provided herein.

A mobile network can be understood as a set of nodes, comprised of one or more IP-subnets, attached to and served by one or more mobile routers (MRs), and mobile as a unit with respect to the rest of the network or the Internet. A mobile network is also referred to herein as a NEMO.

A mobile network node (MNN) is a node in a mobile network.

A mobile network is said to be nested when the mobile network gets attached to another mobile network. The aggregated hierarchy of mobile networks becomes a single nested mobile network or an aggregation.

A local mobile node (LMN) is a mobile node (MN), either a host or a router, that can move topologically with respect to a mobile router (MR) and whose home link belongs to a mobile network connected through the MR.

A visiting mobile node (VMN) is a mobile node (MN), either a host or a router, that can move topologically with respect to a mobile router (MR) and whose home link doesn't belong to a mobile network connected through the MR. A VMN that gets attached to a foreign link within the mobile network obtains an address on that link, i.e., a Care of Address (CoA).

A mobile network prefix is a bit string that comprises a plurality of initial bits of an IP address, the mobile network prefix identifies a mobile network within an Internet topology. All nodes in a mobile network necessarily have an address containing this prefix.

An ingress interface of a mobile router (MR) is an interface attached to a link inside a mobile network.

A root-MR is a mobile router of a root-NEMO used to connect a nested mobile network to a fixed Internet. The root-NEMO is a mobile network at the top of a hierarchy connecting an aggregated nested mobile network to the Internet.

A parent-MR is a mobile router of a parent-NEMO. The parent-NEMO is an upstream mobile network providing Internet access to a mobile network further down the hierarchy.

A sub-MR is a mobile router of a sub-NEMO connected to a parent-NEMO. A sub-NEMO is a downstream mobile network attached to a mobile network up in the hierarchy. It becomes a subservient of a parent-NEMO. The sub-NEMO gets Internet access through the parent-NEMO and does not provide Internet access to the parent-NEMO.

In respect of a mobile device, a neighboring mobile device is a mobile device that is connected to the mobile device and could be an upstream or a downstream mobile device.

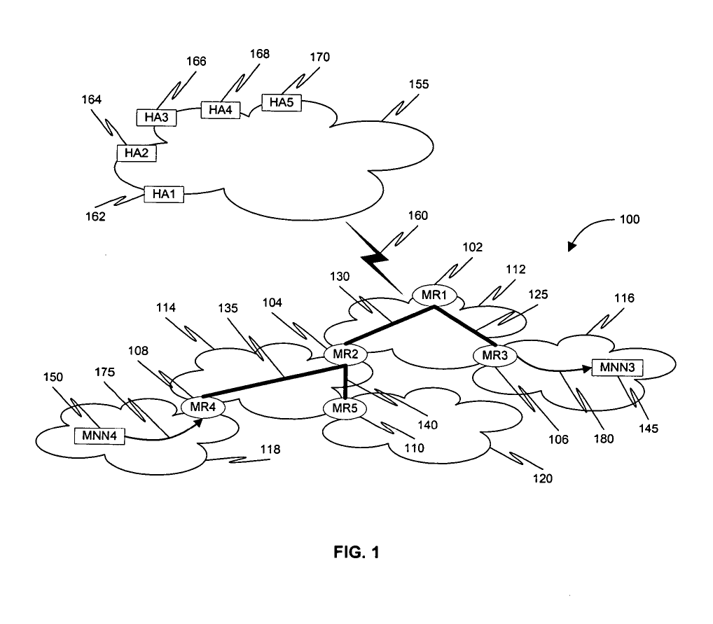

Referring now to the diagrams, and in particular FIG. 1, a block diagram of a plurality of nested mobile networks is shown and indicated generally at 100. The plurality of nested mobile networks 100 is illustrated with five nested mobile networks for clarity of illustration. However, those skilled in the art will realize that a plurality of nested mobile networks may contain many more nested mobile networks or even less than five mobile networks, typically a minimum number being two mobile networks. A nested mobile network typically could comprise a plurality of fixed network nodes and a plurality of fixed routers (not shown, for clarity of illustration) in addition to a plurality of mobile devices or nodes. A mobile device could be a mobile router or a mobile host, and any node in a mobile network (either fixed or mobile) is said to be a Mobile Network Node (MNN). Moreover, a nested mobile network is connected through a mobile router (MR) to an aggregation of plurality of nested mobile networks.

Now, referring back to FIG. 1, the plurality of nested mobile networks 100 comprises a first mobile network node 150 (MNN4) connected through a first mobile router 108 (MR4), and a second mobile network node 145 (MNN3) connected through a second mobile router 106 (MR3). The first mobile router 108 connects a first nested mobile network 118 and the second mobile router 106 connects a second nested mobile network 116. At the top of the plurality of nested mobile networks 100, a root mobile router 102 (MR1) may connect the plurality of nested mobile networks 100 to a core network infrastructure 155. The root mobile router 102 is at the top of the aggregation of plurality of nested mobile networks 100 and also connects the first mobile router 108 to the second mobile router 106.

The first mobile router 108 can be connected to the root mobile router 102 through a plurality of mobile routers, such as a third mobile router 104 (MR2) that connects a mobile network 114. Similarly, the second mobile router 106 can be connected to the root mobile router 102 through a plurality of intermediate mobile routers. Apart from the mobile routers that connect the first mobile router 108 and the second mobile router 106, the plurality of nested mobile networks 100 could comprise of additional mobile routers (for example—a fourth mobile router 110 (MR5) that connects a mobile network 120). Illustrated is a single root mobile router for the sake of simplicity. However, those skilled in the art will realize that one or more root mobile routers could be included in the aggregation without loss of generality. Moreover, as stated earlier, the nesting of mobile networks could go up to any number of nested levels, the nested levels being controlled by hardware and other networking constraints.

For clarity in explanation, the aggregation of plurality of nested mobile networks, in the embodiment explained herein, comprises of five nested mobile networks as illustrated using a plurality of nested mobile networks (112, 114, 116, 118, 120) forming part of the aggregation. A plurality of home agents (162 (HA1), 164 (HA2), 166 (HA3), 168 (HA4), 170 (HA5)) corresponding to the plurality of mobile routers (102, 104, 106, 108, 110) is connected to the core network infrastructure 155. The home agents corresponding to the plurality of mobile routers manage the routing of the information sent to and from the mobile routers while the mobile device is roaming in a foreign network. The aggregation 100 is connected to the core network infrastructure 155 typically by a wireless link 160.

The aggregation of nested mobile networks comprises of an overlay routing topology, the overlay routing topology enabling the aggregation to operate in an autonomous mode. As a part of forming the overlay routing topology, a mobile device (e.g., a mobile router) forming part of the aggregation of nested mobile networks has to discover one or more neighboring mobile devices (e.g. mobile routers) using a discovery process that involves an autonomous mode information exchange mechanism. Any exchange of autonomous mode information with the neighboring mobile devices may be used to populate an autonomous mode routing table (also referred to herein as an AMRT). The autonomous mode information stored in the autonomous mode routing table may be used in the transmission of packets between any two mobile network nodes forming a part of the aggregation.

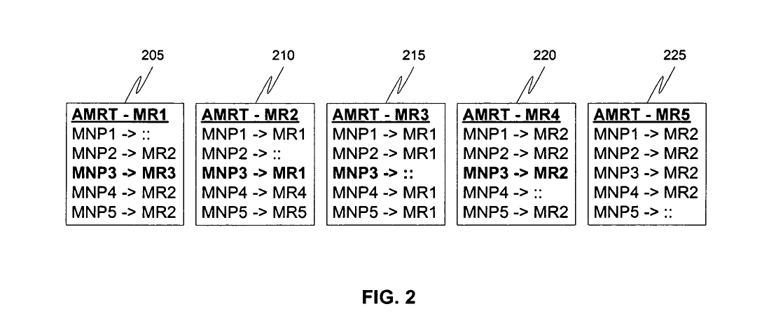

FIG. 2 provides an illustrative view of a plurality of autonomous mode routing tables (205, 210, 215, 220, 225) stored, for instance, at the plurality of mobile routers (102, 104, 106, 108, 110) in accordance with embodiments of the present invention. The illustrative views depicted in FIG. 2 are for explanation purposes only. Actual data that is stored at the autonomous mode routing tables comprises of additional fields that are described later. As shown in FIG. 2, an autonomous mode routing table for a mobile device would typically comprise a mobile network prefix and a direction to a next hop, the next hop being the subsequent mobile device the mobile device may communicate with for further routing. For example, a first autonomous mode routing table 220 corresponding to the first mobile router MR4 has a mobile network prefix MNP3 and a direction MR2 denoting that the third mobile router MR2 104 is the next hop for routing packets towards MNP3. Similarly, an autonomous mode routing table 210 for mobile router MR2 has a mobile network prefix MNP3 and a direction MR1 denoting that the mobile router MR1 is the next hop for routing packets towards MNP3.

As stated earlier, the overlay routing topology enables the aggregation of nested mobile networks to operate in an autonomous mode. The overlay routing topology comprises of a plurality of autonomous mode routing tables stored at least at each of the nested mobile routers. The autonomous mode routing tables are populated based on autonomous mode routing information that may be exchanged between the plurality of nested mobile routers, for example, using an autonomous mode information exchange mechanism.

A distributed approach for support of an autonomous mode in a plurality of nested mobile network could be enabled by an overlay routing topology. In an embodiment of the invention, the overlay routing topology would exist over the plurality of nested mobile networks to provide a distributed nature to the autonomous mode. As stated previously, the overlay routing topology comprises of an autonomous mode routing table (AMRT) created at least at each of the mobile routers forming part of the aggregation of nested mobile networks, and may in some implementations also be created in one or more of the other mobile nodes in the aggregation.

Therefore, in the embodiment mentioned above, the AMRT would be constructed at mobile routers 102, 104, 106, 108, and 110. The AMRT at each mobile device would comprise of information of one or more neighboring mobile devices. In an embodiment of the invention, an AMRT entry would comprise at least of a mobile network prefix (MNP), a mobile network prefix length, a validity lifetime, and the address of a next hop. The MNP of an AMRT entry denotes a prefix of a mobile network that is part of the same aggregation of nested mobile networks as the mobile device. A validity lifetime denotes the amount of time for which the MNP shall remain in the AMRT.

Referring again to FIG. 2, it denotes an illustrative view of the entries stored in the AMRTs 205, 210, 215, 220, and 225 at the mobile devices 102, 104, 106, 108, and 110 respectively. The entries shown in FIG. 2 are for clarity of explanation only and those skilled in the art would appreciate that there could be various possible designs of creating, populating and using the AMRTs. In an embodiment of the invention, the AMRTs forming part of the overlay routing topology could be accessed by using a networking software working at a network layer and forming part of the overlay routing topology.

Consider the embodiment above, wherein the plurality of nested mobile networks was shown with five mobile routers for clarity of explanation. In an embodiment of the invention, a first mobile network node (MNN) 150 may communicate with a second MNN 145 by using the overlay routing topology that enables autonomous mode routing in the plurality of nested mobile networks. The first MNN 150 forms a part of a first mobile network 118 and the second MNN 145 forms a part of a second mobile network 116. Those skilled in the art would appreciate that the specific embodiment of communication between MNN 150 and MNN 145 is considered for clarity and ease of explanation and therefore a device forming part of a first mobile network can communicate with another device forming part of the first or a second mobile network using a similar mechanism.

In order for a packet to be transmitted from the first MNN 150 to the second MNN 145 it may, for instance, be transmitted to the first mobile router (MR) 108 using a default routing table (DRT) and a default, e.g., non-autonomous mode routing mechanism. The DRT forms part of the default routing mechanism, in the plurality of nested mobile networks. The DRT may be used in conjunction with the AMRT when a part of the aggregation of plurality of nested mobile networks is not configured in accordance with embodiments of the present invention. Additionally, if functioning in an autonomous mode may not be possible, the DRT and the default routing mechanism still persist and the network could use the default routing mechanism.

As stated above, a first path 175 from the first MNN 150 to the first MR 108 may use a default routing mechanism. Once the packet reaches the first MR 108, the first MR 108 then ideally refers to a first AMRT 220 and determines that the packet is destined for the second MNN 145, which in the case illustrated would mean routing the packet towards the second mobile network 116 identified by a particular mobile network prefix (for example MNP3 as shown in 220). In order to route the packet towards the second mobile network 116, the packet is in this example transmitted further to the third MR 104 (i.e. MR2 as depicted in 220).

In this illustration, the first MR 108 may transmit the packet to the third MR 104 over a first tunnel 135 (using for example IP-in-IP encapsulation, or other types of encapsulation such as IP-in-UDP etc.) constructed between the first MR 108 and the third MR 104. The first tunnel 135 is constructed for enabling the autonomous mode routing mechanism in the plurality of nested mobile networks as explained later. The first tunnel 135 being an IP tunnel helps in a faster, secured and ideally reliable transfer of packets. For instance, a security protocol such as IPSec, which is well know in the art and will not be described here for the sake of brevity, could be implemented in the IP tunnel so constructed to provide for a secure transfer of packets.

As with the first MR 108, each of the intermediate MRs in the path of the packet to the destination MR may confirm with its corresponding AMRT the next hop in the transmission to facilitate efficiently routing the packet in accordance with the present invention using the AMRT. The third MR 104 and the root MR 102 perform a similar processing by referring, respectively, to a third AMRT 210 and a root AMRT 205 before forwarding the packet to the root MR 102 over a second tunnel 130 and to the second MR 106 over a third tunnel 125 respectively. As stated earlier, the second tunnel 130 and the third tunnel 125 can use IP tunneling for faster, secured and reliable transfer of packets. Once the packet reaches the second MR 106, and since the second MNN 145 forms part of the second mobile network 116 under second MR 106, the second MR 106 could determine, for instance by referring to its corresponding AMRT 215, that the second MNN 145 is a part of the same mobile network and the second MR 106 could, therefore, use a default routing mechanism to forward the packet to the second MNN 145 using a second path 180.

As described above, the overall routing topology comprises of one or more AMRT, each AMRT used for facilitating the routing of packets efficiently and appropriately in accordance with embodiments of the present invention. The AMRT maintained, for example, at each mobile router enables each MR to be aware of all the MRs (or MNPs) in an aggregation of a plurality of nested mobile networks. The initial populating of the AMRT and the subsequent updating of the AMRTs at periodic intervals keeps the MR informed of all the MRs (or MNPs) and changes to the MRs (or MNPs) in the aggregation of the plurality of nested mobile networks. Further, the AMRTs also get updated when a mobile router joins the aggregation, or leaves the aggregation, or moves inside the aggregation. Each MR, by using the awareness of the MRs (or MNPs) in the aggregation of the plurality of nested mobile networks, may communicate with a neighboring MR and this in turn enables an autonomous mode routing between the MR and the neighboring MR. Overall the aggregation of the plurality of nested mobile networks is enabled to communicate in autonomous mode as described earlier.

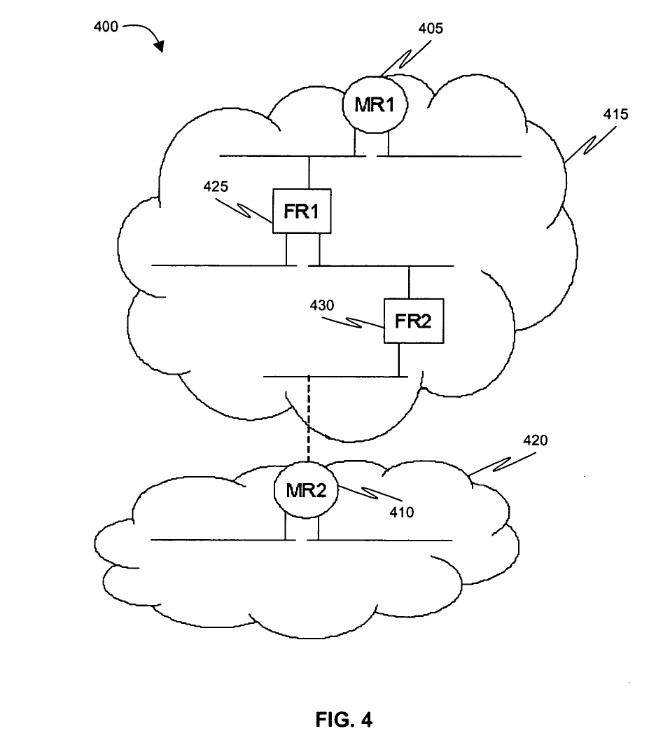

FIG. 4 is an embodiment that shows a connection 400 between a mobile device 410 (e.g., MR2) and a neighboring mobile device 405 (e.g., MR1) forming part of the plurality of nested mobile networks (not shown). The mobile device 410 can comprise a mobile router that connects a mobile network 420 to a neighboring network 415 connected through the neighboring mobile device 405, which is a mobile router. In this illustration, mobile network 415 is a parent NEMO (and MR 405 correspondingly a parent MR) to mobile network 420 (and MR 410 correspondingly a sub-MR), which is a sub-NEMO to mobile network 415. The connection between the mobile device 410 and the neighboring mobile device 405 may comprises of a plurality of fixed routers 425 (e.g., FR1) and 430 (e.g., FR2). Those of ordinary skill in the art would appreciate that the connection could comprise of none, or one or more fixed routers and the embodiment 400 is merely an example to illustrate such a connection, so described for clarity and ease of explanation. The autonomous mode routing enabled and facilitated in accordance with embodiments of the present invention is ideally transparent to the fixed routers that form a part of the plurality of nested mobile networks.

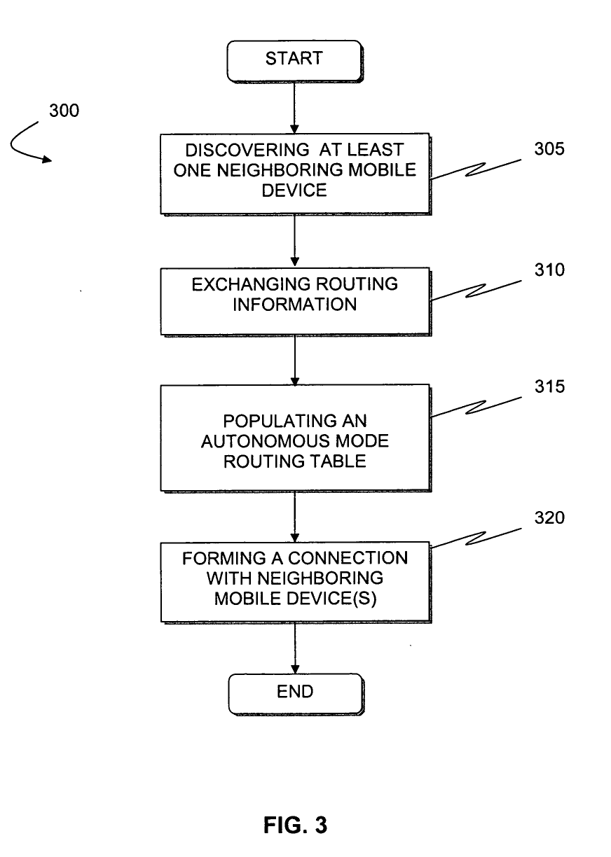

Now, referring to FIG. 3, a flow diagram denoting steps involved in enabling autonomous mode routing between mobile devices forming a plurality of nested mobile networks in accordance with embodiments of the present invention is generally depicted at 300. As depicted in step 305, a mobile device, e.g., 410, discovers at least one neighboring mobile device, e.g., 405, to form an overlay routing topology. The discovery process could be implemented in various forms as explained later. Subsequent to the discovery, as depicted in step 310, the mobile device 410 exchanges routing information with the neighboring mobile device 405 using a plurality of unicast messages as explained in detail below. The routing information comprises of the particulars of the neighboring mobile device, such as a mobile network prefix (MNP), a mobile network prefix length, and a validity lifetime that are stored by the mobile device 410 and may be used later by the mobile device 410 to participate in autonomous mode routing in the plurality of nested mobile networks. The exchanging step could be implemented in various forms as explained later. In order to store the information for later use in the autonomous mode transmission, the mobile device 410 populates an autonomous mode routing table (AMRT), as depicted in step 315. The AMRT is typically further updated periodically or based on certain predetermined parameters or events such that a mobile device such as a MR, e.g., mobile device 410, has complete information of the plurality of nested mobile networks as and when additional mobile devices such as MRs join or leave the aggregation of the plurality of nested mobile networks, or when a mobile device such as a MR moves inside the aggregation. At step 320, a connection may be formed between the mobile devices 405, 410 for enabling autonomous routing between these mobile devices in accordance with embodiments of the present invention.

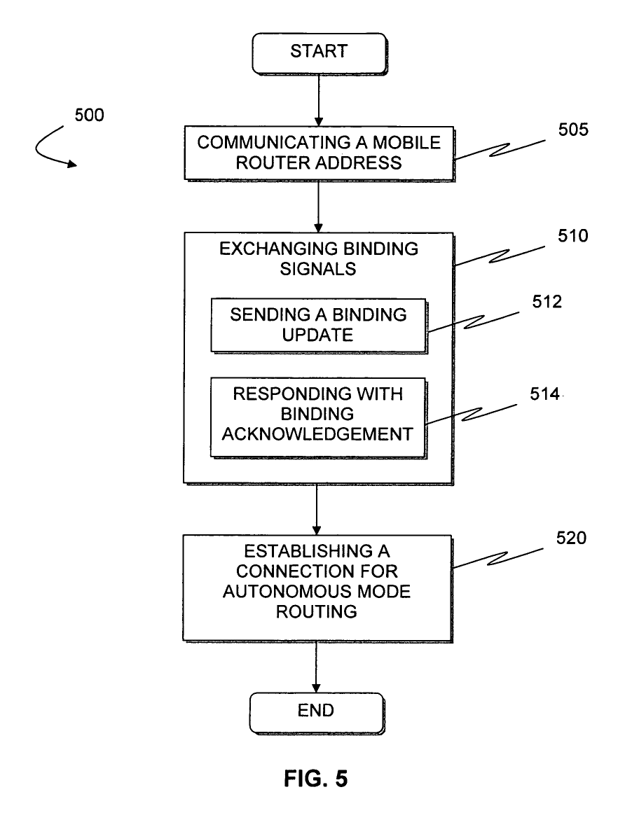

As stated earlier, a mobile device 410 forming part of an aggregation of the plurality of nested mobile networks discovers a neighboring mobile device 405 forming part of the aggregation of the plurality of nested mobile networks to form the overlay routing topology. The mobile device 410 typically discovers the neighboring mobile device 405 before it exchanges routing information with the neighboring mobile device 405. As depicted in FIG. 5, an embodiment denoting the steps of a discovery process 500 comprises the neighboring mobile device 405 communicating with the mobile device 410 for receiving a mobile router address (MRA) of mobile device 405 by mobile device 410, as in step 505. The MRA may, for example, comprise an address of an ingress interface of the MR, a home address of the MR, and a care-of-address of the MR. In another embodiment of the invention, the MRA receive as depicted in step 505 comprises the neighboring mobile device 405 including a MRA option in a router advertisement (RA) message sent by the neighboring mobile device 405. At the fixed routers 425 and 430, the MRA in the RA sent by a fixed router between the neighboring mobile device 405 and the mobile device 410 may be dynamically discovered from the (upstream) RA messages. In the latter case, the fixed routers 425 and 430 between the neighboring mobile device 405 and the mobile device 410 merely copy the MRA in its own router advertisement to be sent to the mobile device 410.

In another embodiment of the present invention, the MRA exchange as in step 505 can comprise of the neighboring mobile device 405 multicasting the MRA to an IP multicast group within a scope limited to a neighboring mobile. In this embodiment, a visiting mobile router, such as the mobile device 410, entering the scope limited to the neighboring mobile router, such as the mobile router 405, may subscribe to the IP multicast group and therefore obtain the MRA of the neighboring mobile device 405. Those of ordinary skill in the art will appreciate that the embodiments mentioned herein for the receipt of the MRA and discovering of the neighboring mobile device are not exhaustive, and there may, therefore, be various other approaches to implement the same.

As a part of the discovery process 500, the mobile device 410 and neighboring mobile device 405 exchange binding signals at step 510 in order to register the mobile device 410 with the neighboring mobile device 405. The exchange of binding signals can comprise mobile device 410 sending a binding update (BU) message, as depicted in step 512, indicating a binding between a home address of the mobile device 410 and a care-of-address (CoA) of the mobile device 410, wherein the CoA is, for example, acquired by mobile device 410 when attaching to mobile network 415 using any suitable means such as is known in the art.

On receiving the BU message, the neighboring mobile device 405 typically checks if the BU is received from a sub-MR (such as mobile device 410) by comparing the CoA included in the BU with its own mobile network prefix (MNP). The neighboring mobile device 405 responds to the BU with a positive binding acknowledge message, at step 514, if the comparison is successful, i.e. if the CoA included in the BU matches with its own MNP. On the other hand, the neighboring mobile device 405 responds with a negative binding acknowledge message in step 514, if the comparison fails or if the neighboring mobile device 405 does not choose to support the autonomous mode with the sub-MR (e.g., mobile device 410). The negative binding acknowledge message implies that there may not be an autonomous mode of communication between the MR and the neighboring MR. The negative binding acknowledge message can comprise, for example, of a plurality of error codes to denote that an autonomous mode routing protocol (AMRP) is not supported or that an autonomous mode prefix (AMP) is not supported. AMRP and AMP are described later.

In case the neighboring mobile device 405 responds with a positive binding acknowledge message (thereby completing the discovery process), the neighboring mobile device 405 and the mobile device 410 may establish a connection, based on a given connectivity between the mobile device 410 and the neighboring mobile device 405, for the autonomous mode routing, as depicted in step 520. For example, in one embodiment the connectivity between the mobile device 410 and the neighboring mobile device could comprise of a plurality of fixed routers. The connection based thereon would typically comprise a tunnel, e.g., an IP tunnel. The tunnel is constructed with a CoA of the mobile device 410 and an address of the neighboring mobile device 405 as the termination points. Thus, when a fixed router is encountered in the connectivity, the tunnel may use IP tunneling (e.g., IP encapsulation techniques) between the mobile device and the neighboring mobile device to achieve transparency to the fixed router. Moreover, the tunnel can be implemented using an existing IPSec tunnel between the neighboring mobile device 405 and the mobile device 410. Similarly, other types of tunneling, other than IPv6-in-IPv6 may be used, as for example IPv6-in-UDPv6 (and respectively IPv4-in-IPv4, IPv4-in-UDP, etc., encapsulation in an IPv4 context). A tunnel would not be required, however, when there are no fixed routers between the mobile device and the neighboring mobile device, in which case the mobile device 410 and the neighboring mobile device 405 can communicate directly using L2 (Layer 2) connectivity between them.

Once a mobile device 410 and a neighboring device 405 have discovered each other, they may exchange routing information and on doing so, may also receive routing information of and from other mobile devices to populate AMRTs at each of mobile device 410 and neighboring mobile device 405. The routing information stored in the respective AMRTs is used by each of these mobile devices to enable autonomous mode routing in accordance with embodiments of the present invention.

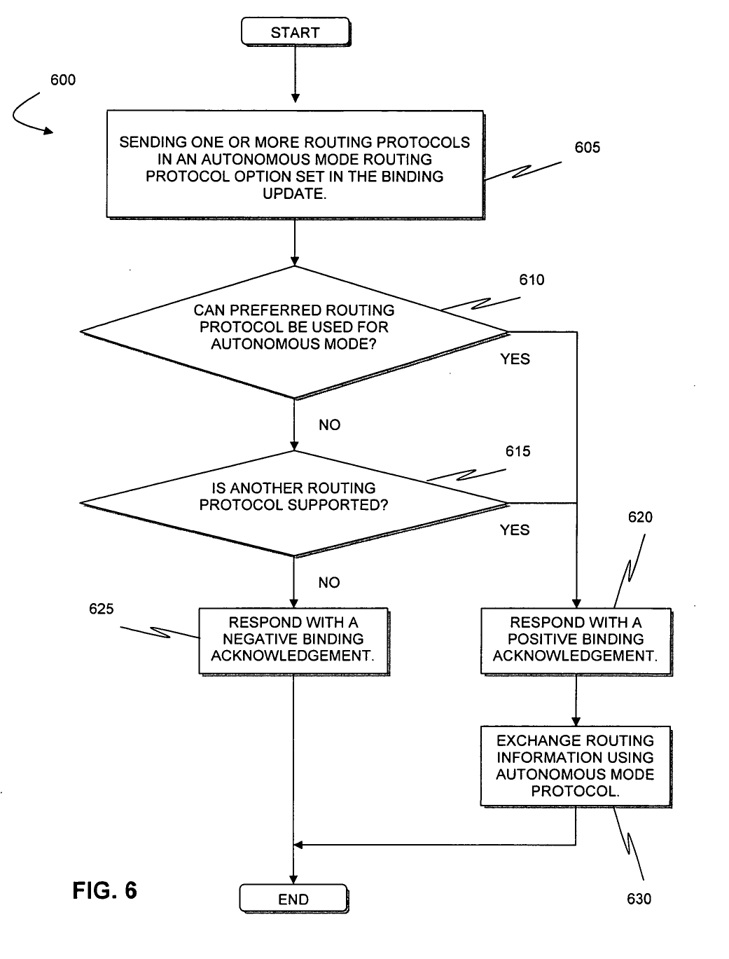

FIG. 6 depicts an embodiment 600 of the invention denoting the steps for receiving routing information, which further comprises negotiating an autonomous mode protocol between a mobile device 410 and a neighboring mobile device 405 for exchanging the routing information. For example, the autonomous mode protocols may include RIP (Routing Information Protocol), OSPF (Open Shortest Path First) or ad-hoc routing protocols. The mobile device 410 and the neighboring mobile device 405 may comprise mobile routers that support a plurality of routing protocols. The mobile device 410 and the neighboring mobile device 405 could comprise a plurality of fixed routers between them. The plurality of fixed mobile routers could support a different set of routing protocols as compared to the plurality of routing protocols supported by the mobile device 410 and the neighboring mobile device 405. Therefore, in one exemplary implementation there could exist two different routing layers, one related to the routing between the fixed routers forming part of a mobile network in the aggregation and the second related to the routing between the mobile devices forming part of the aggregation.

In an embodiment of the invention, the negotiating of the autonomous mode protocol comprises a new option or the autonomous mode routing protocol (AMRP) option, communicated in a binding update (BU) and a binding acknowledge (BA) message exchanged between the mobile device 410 and the neighboring mobile device 405. Since the AMRP option forms a part of the BU and the BA message exchanged between the mobile device 410 and neighboring mobile device 405, the autonomous mode protocol could be negotiated during the discovery step.

As depicted in step 605, the AMRP option is set by the mobile device 410 in the BU it sends to the neighboring mobile device 405. The AMRP option lists one or more routing protocols that are supported by the mobile device 410, and may be classified in a preference order from a preferred routing protocol to lesser-preferred ones. For example, the preference order may be determined based on whether the mobile device 410 is already using a routing protocol as a part of an overlay routing topology, in which case the routing protocol shall be the preferred routing protocol. The one or more routing protocols could be identified by corresponding protocol numbers as assigned by IANA (Internet Assigned Numbers Authority).

On receiving the BU, the neighboring mobile device 405 performs a check, at step 610, to determine whether the preferred routing protocol could be used for the autonomous mode between the neighboring mobile device 405 and the mobile device 410. If, for example, the neighboring mobile device 405 is already a part of an overlay routing topology and uses the preferred routing protocol, it responds with a positive BA message, as depicted in step 620, thereby conveying that the preferred routing protocol could be used in the autonomous mode routing between it and the mobile device 410. In the case where the neighboring mobile device 405 is not a part of an aggregation of a plurality of nested mobile networks, but supports the preferred routing protocol, it may still respond with a positive BA message, as depicted in step 620, thereby conveying that the preferred routing protocol could be used in the autonomous mode routing between the neighboring mobile device 405 and the mobile device 410.

In case the preferred routing protocol cannot be used, the neighboring mobile device 405 may, in step 615, determine whether a compatible routing protocol exists from amongst a plurality of routing protocols sent in the BU. The neighboring mobile device 405, responds with a positive BA message comprising the compatible routing protocol, as in step 620, thereby conveying that the compatible routing protocol could be used in the autonomous mode routing between the neighboring mobile device 405 and the mobile device 410. In case the neighboring mobile device 405 is already a part of an overlay routing topology, and a routing protocol used by the neighboring device 405 in the overlay routing topology is different from the compatible routing protocol so selected, the neighboring mobile device will have to act as a routing gateway between the routing protocol already used by neighboring mobile device 405 and the compatible protocol. If the neighboring mobile device 405 is not able to act as a routing gateway between, then the autonomous mode will not be fully supported between the mobile network 415 connected by the neighboring mobile device 405 and the mobile network 420 connected by the mobile device 410. In case the neighboring mobile device 405 and the mobile device 410 are not able to concur on the preferred routing protocol or a compatible routing protocol, the autonomous mode will not be supported between the mobile device 410 and the neighboring mobile device 405, and the neighboring mobile device 405 will respond with a negative BA as indicated at step 625. Once the autonomous mode protocol to be used between the mobile device 410 and the neighboring mobile device 405 has been negotiated, routing information can be exchanged using the autonomous mode protocol as indicated at step 630.

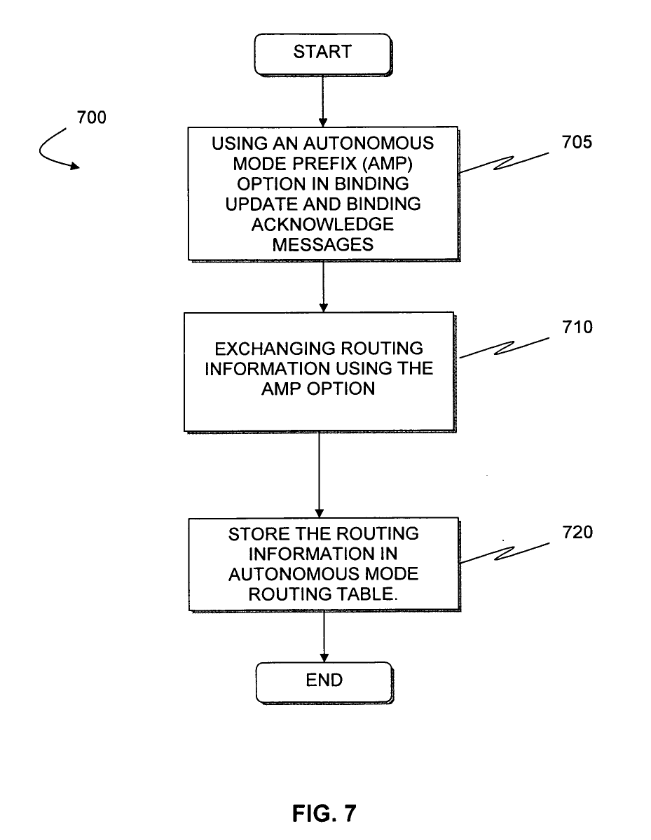

FIG. 7 depicts an embodiment 700 of the invention denoting the steps for receiving routing information by relying on an autonomous mode prefix (AMP) option to be used in a BU message and a BA message as in step 705. The AMP option may comprise of a mobile network prefix (MNP), a MNP length, and a validity lifetime. The MNP is not necessarily a mobile network prefix of a mobile device sending the BU. The MNP may be a prefix that belongs to another mobile device in the same aggregation of plurality of nested mobile networks as the mobile device. The validity lifetime defines the amount of time for which the MNP can remain in an autonomous mode router table (AMRT). In an embodiment of the invention, where the mobile device 410 and the neighboring mobile device 405 are already part of an aggregation of plurality of nested mobile networks, the BU and BA message exchanged between the mobile device 410 and the neighboring mobile device 405 may include a plurality of AMP options each having a MNP and a validity lifetime corresponding to a mobile network forming part of an aggregation under the mobile device or the neighboring mobile device. Each MR in the aggregation typically maintains an AMRT, which contains routes for a plurality of mobile networks forming the aggregation.

As depicted in step 710, the neighboring mobile device 405 and the mobile device 410 exchange the routing information directly by using the AMP option in the BU and the BA. Therefore, as per the earlier embodiment, there is no need to negotiate an autonomous mode protocol for exchanging the information. The mobile device 410 and neighboring mobile device 405 stores the routing information in the AMRT as in step 720. Since each of the mobile devices sends the routing information to its neighboring mobile device, it is desirable to ensure that the routing information propagation, using the AMP option, does not turn into an endless loop. In order to avoid the endless loop, the neighboring mobile device 405 receiving the BU from the mobile device 410 may check whether any of the prefixes advertised in the AMP options belongs to the neighboring mobile device's own MNP. In such a case, the neighboring mobile device would respond with a negative BA, denoting that the autonomous mode would not be supported.

In the aggregation of a plurality of nested mobile networks, an autonomous mode routing table (AMRT) stored at each mobile device operating in accordance with embodiments of the present invention keeps a mobile device informed of the other mobile devices in the aggregation (and more precisely of all the MNPs in the aggregation) and therefore facilitates autonomous mode routing in the aggregation. Therefore, in order to enable autonomous mode routing in the aggregation, the AMRT is generated based on routing information exchanged between the mobile devices.

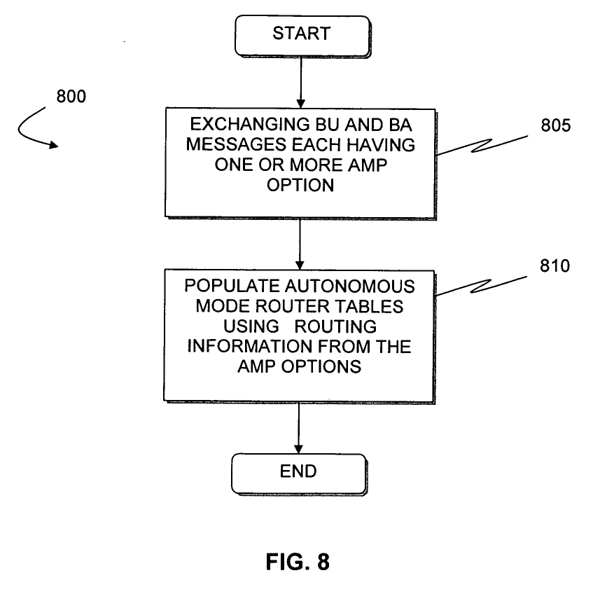

FIG. 8 is an embodiment 800 depicting the steps involved in generating the AMRT based on the routing information exchanged between a mobile device and a neighboring mobile device. In general, at step 805 the mobile device 410 and the neighboring mobile device 405 exchange BU and BA messages, each having one or more AMP options that contain their respective routing information. At step 810, the mobile device 410 and the neighboring mobile device 405 populate their respective AMRTs using that routing information. An entry created in the AMRT may comprise a mobile network prefix (MNP), a MNP length, a validity lifetime, and autonomous mode tunnel information. The autonomous mode tunnel information typically includes an autonomous mode tunnel destination IP address and an autonomous mode tunnel source IP address. On receiving an AMP option (containing the routing information) from a mobile device 410, a neighboring mobile device 405 may create the entry. Those skilled in the art will further realize that the BU from mobile device 410 can include several AMP options, e.g., one for each mobile network prefix contained in its AMRT at the time mobile device 410 joins mobile network 415. Hence, upon receiving such a BU with several AMP options, the neighboring mobile device 405 would typically create several entries in its AMRT, one for each AMP option.

As stated earlier, the neighboring mobile device 405 will check and determine whether the autonomous mode is possible. For example, it would not be possible if one of the MNP in the routing information is the network mobile prefix of the neighboring mobile device itself. In case the autonomous mode is possible, then the neighboring mobile device 405 would send a positive binding acknowledgment message (BA) and create the AMRT entries based on the routing information. An AMRT entry will be created for each of the AMP options received, and each entry would be populated with the MNP, MNP length and validity lifetime of the AMP option as received in the routing information from the mobile device 410. Moreover, an autonomous mode tunnel destination IP address may be set to that of a Care-of-Address (CoA) of the mobile device 410 (as obtained in the Binding Update message) and an autonomous mode tunnel source IP address may be set to the address of the neighboring mobile device 405. The validity lifetime denotes the time until the entry expires. For a MNP corresponding to the neighboring mobile device, the entry may be populated to convey that a default router table (DRT) is to be used, as opposed to an autonomous mode. Further, the positive BA message sent by the neighboring mobile device 405 to the mobile device 410 comprises one or more AMP options corresponding to a MNP and a validity lifetime for each prefix contained in the AMRT at the neighboring mobile device 405, except for prefixes which are reachable through the mobile device 410 as indicated by the AMRT of the neighboring mobile device 405. The mobile device 410 populates the AMRT based on the AMP option(s) received from the neighboring mobile device 405 in a similar manner as it is done at the neighboring mobile device, as explained above.

Once an entry is created in an AMRT, the entry is ideally updated as and when new mobile devices (and networks) join the aggregation of a plurality of nested mobile networks and when existing mobile devices (and networks) leave the aggregation, as well as when existing mobile devices (and networks) move inside the aggregation. The present invention provides an autonomous mode prefix (AMP) refresh message that helps to propagate information required to update an AMRT. The AMP refresh would typically be continuously exchanged between the mobile devices forming part of the aggregation to update an AMRT with respect to a mobile network joining or leaving the aggregation, or moving inside the aggregation.

Therefore as explained with respect to embodiment 800, of the invention, the mobile device 410 and the neighboring mobile device 405, during a formation of an aggregation of plurality of nested mobile networks. exchange a binding update (BU) and a binding acknowledge (BA). The BU and BA may include one or more AMP options (e.g., one or more MNPs, and one or more validity lifetimes) corresponding to one or more mobile networks forming part of an aggregation of the mobile device 410 (in the Binding Update message) and the neighboring mobile device 405 (in the Binding Acknowledgement message). Once the BU and BA messages are exchanged and the AMRTs are generated at both the mobile device 410 and the neighboring mobile device 405. Subsequent updates to the AMRTs may be carried out based on periodic exchanges of BU and BA messages between the mobile device 410 and the neighboring mobile device 405. Following each of these BU and BA exchanges (including the initial exchange at the time the mobile device 410 and the neighboring mobile device 405 have discovered each other), each of the mobile device 410 and the neighboring mobile device 405 may propagate the changes made in their AMRT to their respective other neighboring mobile devices using AMP refresh messages, so that those other neighboring mobile nodes can also update their respective AMRTs.

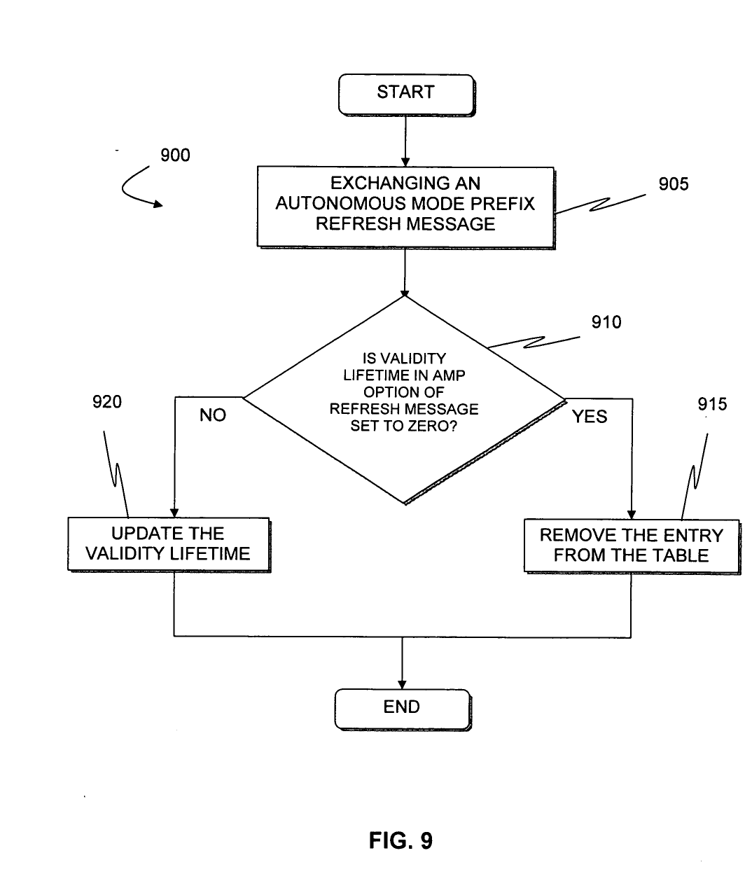

Referring now to FIG. 9, which is an embodiment 900 depicting the steps involved in updating an AMRT using an AMP refresh message. As shown in embodiment 900, a neighboring mobile device, e.g., MR5 may receive the AMP refresh message from the mobile device 410, as depicted in step 905. The AMP refresh message comprises at least one AMP option, similar to an AMP option forming part of the BU and BA messages discussed earlier, and may comprise at least one MNP prefix and a validity lifetime. The AMP refresh message can include a plurality of AMP options (each having a MNP and a corresponding validity lifetime) corresponding to a plurality of mobile networks forming part of an aggregation of the mobile device 410 and the neighboring mobile device 405. If the validity lifetime in an AMP option of the AMP refresh received from the mobile device 410 is set to zero as in step 910, the neighboring mobile device removes the entry associated with the MNP included in that AMP option, as depicted in step 915. In case of a non-zero value in the validity lifetime, the AMRT entry is updated to the value of validity lifetime as obtained from the AMP option in the AMP refresh message, as in step 920. Updates to the AMRT at the mobile device or the neighboring mobile device may occur when a mobile network either joins the aggregation or leaves the aggregation or moves within the aggregation. It should also be realized that the AMRT update process described above by reference to FIG. 9 can also be implemented when a similar binding update or binding acknowledgement message is received with an AMP option.

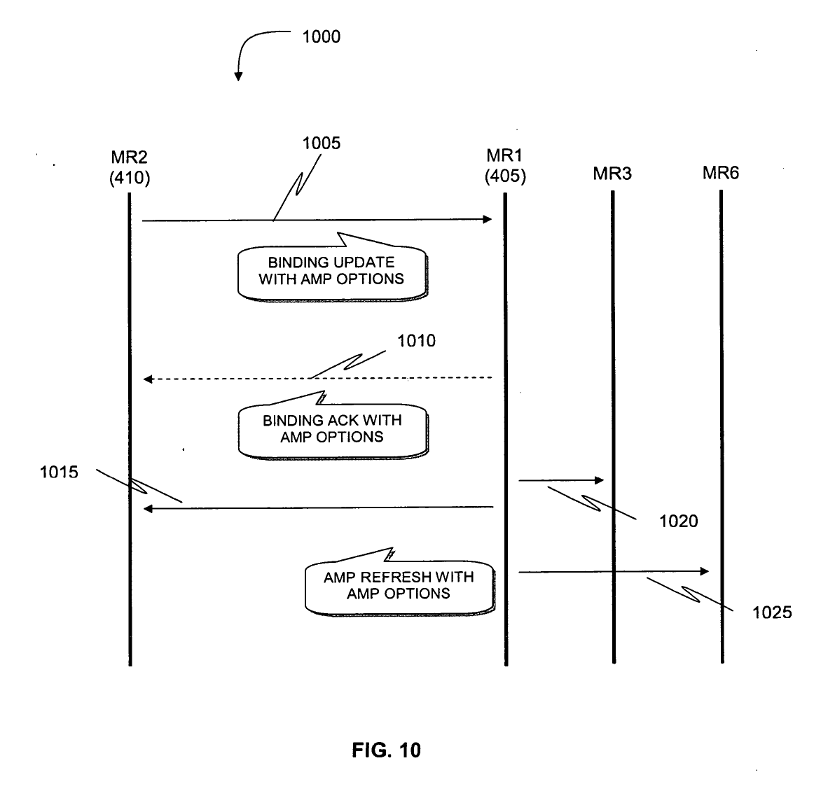

Referring now to FIG. 10, which illustrates an overall sequence of events that occur for generating and updating an AMRT in an aggregation in accordance with embodiments of the invention. The embodiment 1000 comprises a smaller embodiment of the invention and is referred to herein only for purposes of clarity and understanding. Those skilled in the art would appreciate that the embodiment 1000 shall not be construed so as to be exhaustive or restricting in any manner of the present invention. Consider, for example, that a mobile network connected through a mobile device 410 (MR2) merging with a neighboring mobile network connected through a neighboring mobile device 405 (MR1). Consider further, for example, that the neighboring mobile device 405 is already connected to two other neighboring mobile devices, namely a first mobile device (e.g., MR3) and a second mobile device (e.g., MR6) before the mobile device 410 merges with the neighboring mobile device 405. Therefore, a first AMRT of the neighboring mobile device 405 can comprise three entries, each entry including a mobile network prefix and a validity lifetime. A first entry can comprise a default indicator to denote the neighboring mobile network 415 itself. The first entry can have a first validity lifetime of infinity, since the first entry would never expire. A second entry and a third entry would comprise a second mobile network prefix and a second validity lifetime, and a third mobile network prefix and a third validity lifetime corresponding to the first mobile device and the second mobile device respectively.

Referring again to embodiment 1000 depicted in FIG. 10, during the merging of the mobile device 410 with the neighboring mobile device 405, at step 1005, the mobile device 410, as explained earlier, sends a binding update signal (BU) to the neighboring mobile device 405. Assuming, for sake of simplicity, that the mobile device 410 does not comprise of a nested mobile network beneath it, the BU can comprise an AMP option, the AMP option comprising a mobile network prefix (MNP) corresponding to the mobile network 420 under the mobile device 410, and a predetermined validity lifetime. The predetermined lifetime could be a value that can be determined based on various parameters such as the rate at which mobile networks move across an aggregation. On receiving the BU, and in case of a successful binding, the neighboring mobile device 405, can create a fourth entry in the first AMRT at the neighboring mobile device 405, the fourth entry comprising the MNP prefix and the validity lifetime received from the mobile device 410 in the AMP option. In response to the BU and as depicted in step 1010, the neighboring mobile device 405 would, as explained earlier, send a binding acknowledge (BA) to the mobile device 410. The BA would include three AMP options corresponding to the first entry, the second entry and the third entry in the first AMRT at the neighboring mobile device 405. That is, the BA message typically includes an AMP option for each of the entries of the first AMRT at the neighboring mobile device 405 except the ones (i.e. the fourth entry created upon reception of the BU message) that are indicating the mobile device 410 as the next hop. On receiving the plurality of AMP options, the mobile device 410 can update a second AMRT at the mobile device 410. The second AMRT would comprise four entries, three of which correspond to and are populated from the three AMP options received from the neighboring mobile device 405 and a fourth entry (which was existing prior to receiving the BA message) corresponding to the mobile network under the mobile device 410. Those three new entries correspond to the mobile network prefixes of the first mobile device MR3, the second mobile device MR6, and the neighboring mobile device 405. All of them indicate the neighboring mobile device 405's address as the next hop.

In addition to sending the BA message to the mobile device 410, the neighboring mobile device 405 also needs to propagate the changes made to its AMRT (i.e. the new entry with the mobile network prefix corresponding to mobile device 410, created using the routing information in the BU message received from mobile device 410) towards its other neighboring mobile devices which are the first mobile device and the second mobile device, at 1020 and 1025 respectively. For this, the neighboring mobile device 405 sends an AMP Refresh message (including an AMP option with the mobile network prefix of the mobile device 410) to each of the first and second mobile devices. Upon receiving this message, each of them may update its own AMRT to include a new entry with a prefix set to the mobile network prefix corresponding to mobile device 410 and next hop set to the address of the neighboring mobile device 405 from which the AMP Refresh was received. If the first mobile device and the second mobile device each also had other neighbors in addition to the neighboring mobile device 405, they would also need to propagate the change made to their AMRT (i.e. the new entry for mobile network prefix corresponding to mobile device 410) towards these other neighbors using AMRT Refresh messages. Thus, an entry in an AMRT is kept updated by subsequent and continual exchange of BU, BA messages and resulting AMP refresh messages.

Similarly, if the first mobile device MR3 connected to the neighboring mobile device 405 has been disconnected, and the neighboring mobile device 405 has discovered that the first mobile device is not reachable anymore, it would remove the entry corresponding to the prefix of the first mobile device from its AMRT. In addition the neighboring mobile device 405 should also propagate this change made to its AMRT towards its neighbors. For this, an AMP refresh message 1015 can be sent by the neighboring mobile device 405 to the mobile device 410 and another AMP refresh message (not shown) can be sent by the neighboring mobile device 405 to the second mobile device MR6. These two AMP refresh messages would comprise of one AMP option corresponding to the prefix of the first mobile device MR3 and having a validity lifetime set to zero. On receiving the AMP refresh message 1015, the mobile device 410 would delete an entry corresponding to the prefix of the first mobile device in the second AMRT at the mobile device 410. Similarly, on receiving the other AMP refresh message, the second mobile node MR6 would delete the entry corresponding to the prefix of the first mobile device from its AMRT.

When a mobile device, e.g., 410 leaves the aggregation, it could explicitly deregister itself by sending a Binding Update message to a neighboring mobile device, e.g., 405. This Binding Update will typically include an AMP option with validity lifetime set to zero for each prefix in the mobile device 410's AMRT except the ones pointing to the neighboring mobile device 405. However, those skilled in the art would appreciate that explicit deregistering is not mandatory and a mobile device could detect that a neighboring mobile device has left the aggregation by any other suitable method, such as those known in the art. In an embodiment of the invention, a mobile device could discover that a neighboring mobile device has left the aggregation on receiving an ICMPv6 “destination unreachable” error message when trying to tunnel traffic, and further update the AMRT. The mobile device may further propagate the changes to the AMRT by way of AMP Refresh messages sent to other neighboring mobile devices.

In summary, any change made in an AMRT of a mobile device, typically other than the natural expiration of an entry (i.e. expiration of validity lifetime), should be propagated by the mobile device towards all its neighboring mobile devices except the one that is indicated as the next hop in the AMRT entry. Such a change may include, for instance:
A new entry that is added (upon receiving a BU, a BA or an AMP refresh message), e.g. when a new mobile device joins the aggregation;
An existing entry that is explicitly removed upon receiving an AMP options with a validity lifetime set to zero (in a BU or an AMP Refresh message), or upon detecting that a neighboring mobile device is not reachable anymore through any means; and
An existing entry whose validity lifetime has been updated upon receiving an AMP options with a non-null validity lifetime (in a BU, a BA, or an AMP refresh message).
   Such changes to the AMRT are ideally propagated using the AMP refresh message.

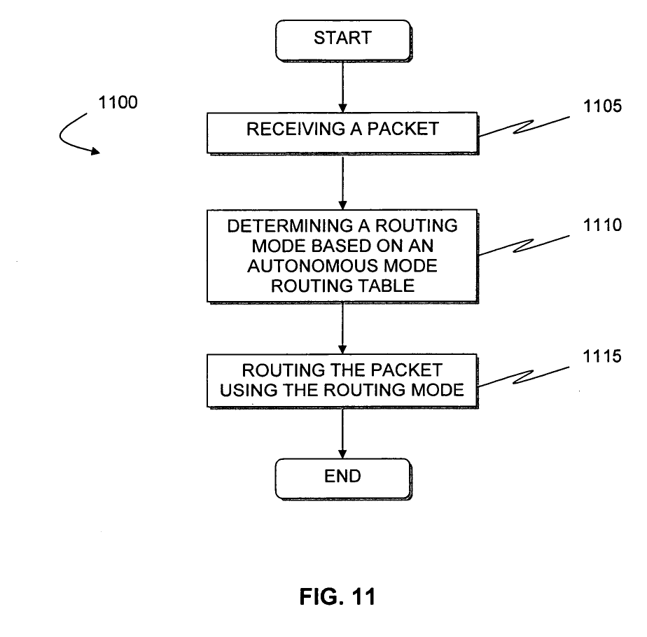

Once a plurality of AMRTs is set up at a plurality of mobile devices forming an aggregation, a packet could be routed in an autonomous mode in the aggregation. FIG. 11 is an embodiment 1100 of routing in the aggregation based on the AMRT. A mobile device forming part of the aggregation, receives the packet as in step 1105, from a first neighboring mobile device. As depicted in step 1110, the mobile device determines whether the packet would be routed in the autonomous mode (using an autonomous mode routing path) or default routing mode (using a default mode routing path) by, for example, checking the AMRT for at least one entry matching a destination address of the packet. In an embodiment of the invention, the mobile device uses an entry with a highest validity lifetime, when there are multiple entries matching in the AMRT. The mobile device routes the packet using the entry from the AMRT as in step 1115 to a second neighboring mobile device. In case there is no matching entry in the AMRT, the mobile device routes the packet using a default routing table (DRT) as in step 1115. Such a scenario, where there is more than one matching entry is possible when for instance a mobile device moves from a first parent to another in the same aggregation without explicitly de-registering from the first parent. Further, in an embodiment of the invention, in the autonomous mode, the packet is routed over an IP tunnel between the mobile device and the second neighboring mobile device using an IP encapsulation. In another embodiment, the packet is routed by sending it to a Layer 2 address corresponding to an IP address of the second neighboring mobile device.

As stated earlier, an aggregation comprising of a plurality of nested mobile networks could operate in an autonomous mode when the aggregation is disconnected from a main network infrastructure. The aggregation could also operate in the autonomous mode even when the aggregation is connected to the main network infrastructure. In an embodiment of the invention, a mechanism could be provided by which a mobile device in the aggregation of nested mobile networks can learn, from a root mobile device for instance, when the aggregation is disconnected from the main network infrastructure. The mechanism may be facilitated by an autonomous mode announcement (AMA) option that may be placed in router advertisement (RA) messages sent by the root mobile device and relayed by any other devices (routers) in the aggregation (e.g. all fixed and mobile routers) in their own RA messages, so that the option reaches all devices in the aggregation. The mobile device may decide to maintain an AMRT and route according to it based on the values received in the AMA option received from a neighboring mobile device. Those skilled in the art would appreciate that there could be various methods of configuring when the aggregation would work in the autonomous mode.

Further, in an embodiment of the invention, the mobile device using an autonomous mode routing could be a visiting mobile node. In the case of the visiting mobile node, a mobile network prefix (MNP) could be replaced by a visiting mobile node home address. As opposed to a mobile router, a visiting mobile host has no mobile network prefix but instead a home address (which could be also seen as a prefix delimiting a range of one and only one IP address). As a consequence, the home address of the visiting mobile host would appear in the AMRT of the other mobile devices (routers or hosts) in the aggregation, as well as in the AMP options relating the said host, in place of a mobile network prefix (MNP).

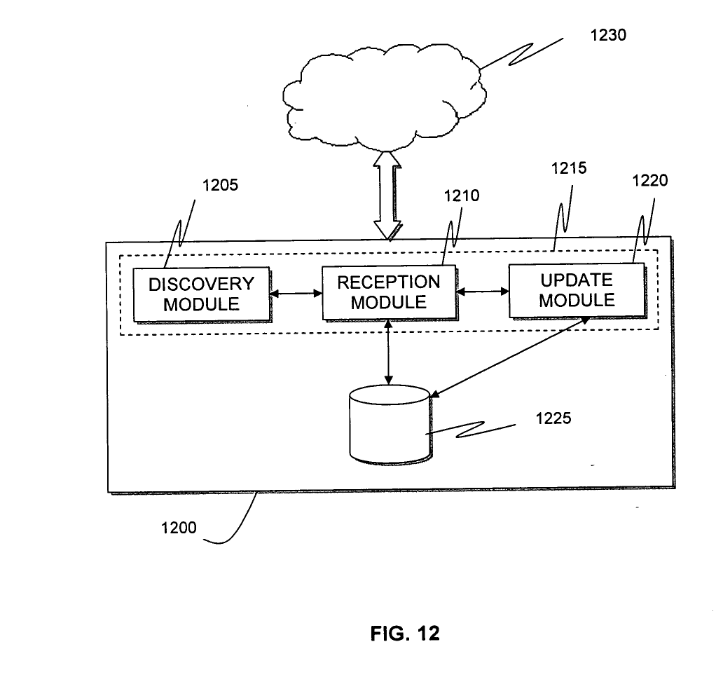

An overlay routing topology covering a plurality of nested mobile networks enables an autonomous mode routing in the plurality of nested mobile networks. As stated earlier, the mobile device comprises of an autonomous mode routing table (AMRT) that forms a part of the overlay routing topology. FIG. 12 is an embodiment of the mobile device 1200 capable of autonomous mode routing and connected to an aggregation 1230. In order to enable the autonomous mode, the mobile device 1200 comprises of a discovery module 1205 to discover at least one neighboring mobile device, a reception module 1210 to receive routing information from the at least one neighboring mobile device, and an update module 1220 to generate an AMRT (not shown) using the routing information. The AMRT may be stored in an autonomous mode routing database 1225. In an embodiment of the invention, the discovery module, the reception module, and the update module would involve network level programming. Further, the discovery module, the reception module, and the update module could form part of a mobile device autonomous routing application 1215 that may be implemented, for example, using suitable hardware (e.g., a processor and at least one memory device that includes the routing database) and software typically stored in the memory and executed by the processor for implementing the above-described embodiments of the present invention.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A method for enabling autonomous mode routing between mobile devices in a plurality of nested mobile networks, the method comprising the steps of:
discovering at least one neighboring mobile device;
exchanging routing information with the at least one neighboring mobile device using a plurality of unicast messages;
populating an autonomous mode routing table (AMRT) using the routing information, wherein the AMRT includes at least an entry corresponding to each mobile network in the plurality of nested mobile networks; and
forming a connection with the at least one neighboring mobile device for enabling autonomous mode routing with the at least one neighboring mobile device.

2. The method of claim 1 further comprising the steps of:
receiving a message from a neighboring mobile device; and
updating the AMRT based on the message.

3. The method of claim 2, wherein the received message comprises one of:
a binding update message including an autonomous mode prefix (AMP) option that comprises at least one mobile network prefix (MNP) and corresponding validity lifetime;
a binding acknowledgement message including an AMP option that comprises at least one MNP and corresponding validity lifetime; and
an AMP refresh message including an AMP option that comprises at least one MNP and corresponding validity lifetime.

4. The method of claim 1 further comprising the step of transmitting a message to a neighboring mobile device for enabling the mobile device to update a corresponding AMRT.

5. The method of claim 4, wherein the transmitted message comprises one of:
a binding update message including an autonomous mode prefix (AMP) option that comprises at least one mobile network prefix (MNP) and corresponding validity lifetime;
a binding acknowledgement message including an AMP option that comprises at least one MNP and corresponding validity lifetime; and
an AMP refresh message including an AMP option that comprises at least one MNP and corresponding validity lifetime.

6. The method of claim 1, wherein the step of discovering the at least one neighboring mobile device comprises the steps of:
receiving a message from the neighboring mobile device that includes an address for the neighboring mobile device;
transmitting a binding update message to the neighboring mobile device; and
receiving a binding acknowledgement message from the neighboring mobile device.

7. The method of claim 6, wherein the address for the neighboring mobile device is received in one of a router advertisement message and a multicast message.

8. The method of claim 6, wherein the binding update and binding acknowledgement messages each comprise one of mobile internet protocol (IP)v6 messages and mobile IPv4 messages.

9. The method of claim 1, wherein the connection is one of an internet protocol (IP) tunnel and a Layer 2 connection.

10. The method of claim 9, wherein the IP tunnel is secured using an IPSec protocol.

11. The method of claim 9, wherein the method is implemented in a first mobile device and the IP tunnel is characterized by a care-of-address of the first mobile device and an IP address of a neighboring mobile device.

12. The method of claim 1, wherein the step of exchanging routing information comprises the steps of:
negotiating an autonomous routing protocol with the at least one neighboring mobile device using at least one mobile internet protocol (IP) message; and
exchanging the routing information using the negotiated autonomous routing protocol.

13. The method of claim 10, wherein the at least one mobile IP message comprises one of at least one mobile IPv4 message and at least one mobile IPv6 message.

14. The method of claim 1, wherein the step of exchanging routing information comprises the steps of:
transmitting a binding update message to a neighboring mobile device; and
receiving a binding acknowledgement message from the neighboring mobile device, wherein the binding update and acknowledgement messages include the routing information.

15. The method of claim 1, wherein the routing information comprises at least one mobile network prefix, mobile network prefix length, and validity lifetime.

16. The method of claim 1 further comprising the step of transmitting a packet, the transmitting step comprising the steps of:
receiving the packet from a first neighboring mobile device;
determining one of an autonomous routing path based on the AMRT and a default routing path based on a default routing table; and
forwarding the packet using one of the autonomous routing path and the default routing path.

17. The method of claims 16, wherein the packet is forwarded to a second neighboring mobile device via one of:
an internet protocol (IP) tunnel using an IP encapsulation; and
a Layer 2 connection.

18. A method for enabling autonomous mode routing between mobile devices in a plurality of nested mobile networks, the method comprising the steps of:
discovering at least one neighboring mobile device, the discovering step comprising:
receiving a message from the neighboring mobile device that includes an address for the neighboring mobile device;
transmitting a binding update message to the neighboring mobile device; and
receiving a binding acknowledgement message from the neighboring mobile device;
exchanging routing information with the at least one neighboring mobile device using a plurality of unicast messages;
populating an autonomous mode routing table (AMRT) using the routing information, wherein the AMRT includes an entry corresponding to each mobile network in the plurality of nested mobile networks; and
forming a connection with the at least one neighboring mobile device for enabling autonomous mode routing with the at least one neighboring mobile device.

19. A mobile device capable of an autonomous mode routing in a plurality of nested mobile networks, the device comprising:
a processor; and
at least one memory device, wherein at least one of the processor and the at least one memory device is operable for:
discovering at least one neighboring mobile device;
exchanging routing information with the at least one neighboring mobile device using a plurality of unicast messages;
populating an autonomous mode routing table (AMRT) using the routing information, wherein the AMRT includes an entry corresponding to each mobile network in the plurality of nested mobile networks; and
forming a connection with the at least one neighboring mobile device for enabling autonomous mode routing with the at least one neighboring mobile device.

20. The mobile device of claim 19 comprising one of a mobile host and a mobile router.
